(19) United States
(12) Patent Application Publication
(10) Pub. No.: US 2023/0212420 A1
(43) Pub. Date: Jul. 6, 2023

(54) GELCOAT COMPOSITIONS FOR SANITISED WATER POOLS

(71) Applicant: ABBEYTEX PTY LTD, Tullamarine, Victoria (AU)

(72) Inventors: Laurance Alan Beston, Tullamarine, Victoria (AU); Christopher Brian King, Auckland (NZ)

(21) Appl. No.: 17/998,182

(22) PCT Filed: May 5, 2021
(86) PCT No.: PCT/AU2021/050413

§ 371 Date: Nov. 8, 2022

(30) Foreign Application Priority Data
May 8, 2020 (AU) 2020901484

(51) Int. Cl. C09D 175/06; C09D 7/62; C09D 5/16; C09D 5/29; C09D 7/20; C08J 7/04

(52) U.S. Cl. CPC C09D 175/06; C09D 7/62; C09D 5/1662; C09D 5/1687; C09D 5/29; C09D 7/20; C08J 7/0427; C08J 2375/06

(57) ABSTRACT

The invention provides a gelcoat composition for coating a sanitised water pool, the composition comprising: curable polymeric components comprising: (i) an unsaturated polyester base resin and (ii) a polyester-polyurethane prepolymer, wherein the polyester-polyurethane prepolymer is terminally functionalised with polymerizable ethylenically unsaturated functional groups; and reactive diluent, wherein the unsaturated polyester base resin is present in an amount of greater than 50 wt. % of the curable polymeric components, and wherein the polyester-polyurethane prepolymer is present in an amount of no more than 25 wt. % of the gelcoat composition.

### TECHNICAL FIELD

The present invention relates to a gelcoat composition for coating a sanitised water pool, comprising an unsaturated polyester base resin, a polyester-polyurethane prepolymer terminally functionalised with polymerizable ethylenically unsaturated functional groups and reactive diluent. The invention also relates to polyester-polyurethane prepolymers for use in a gelcoat composition, to coated particulates for use in a gelcoat composition, comprising decorative particles coated with a curable resin composition comprising a polyester-polyurethane prepolymer, and to a method of coating a pool.

### BACKGROUND OF INVENTION

Gelcoat compositions comprising unsaturated polyester base resins have been used for decades to manufacture swimming pools. Fibre reinforced plastic pools generally have a decorative, for example pigmented, unsaturated polyester gelcoat to provide chemical resistance to the water and pool chemicals used to keep the pool sanitized. The gelcoat is backed up by a structural system, usually fiberglass laminate, to provide the physical strength needed to hold the weight of water.

Historically, a pool owner would test the water and manually add sanitising chemicals, such as calcium hypochlorite, acids or alkali, etc., to correct the chemistry and apply the appropriate level of sanitation (bleach). However, in recent years there has been substantial changes to these practices. Increasingly, automated systems are used, such as ozone systems and salt systems (e.g. using sodium chloride, magnesium chloride or various mineral salts). In salt systems such as common salt water pool chlorinators the salt is electronically dissociated using an electrolytic cell.

Automated sanitizing systems are often sold as being a “switch on and leave on” system, with automated pH and chlorine addition controls. However, this approach can lead to very high chlorine and high pH levels if not correctly monitored and maintained. Furthermore, pool blankets trap sanitising agents (chlorine) near the surface and elevate temperature creating a thermocline in the pool, whilst pool heaters further exacerbate these aggressive chemical conditions. Pool owners are generally oblivious to the problems caused by excessive sanitisation, as the pool will appear crystal clear. Even pool maintenance companies are fallible all too often in regard to their customers' pool care. The Australian Standard AS1838 calls for chlorine levels of 1-3 ppm and pH of 7.2-7.4, but it is not uncommon to find 15-20 ppm of chlorine and pH's of 8.8+ in swimming pools.

These out of balance conditions can lead to chemical attack of the gelcoat surface, with a subsequent deterioration, fading and whitening in the appearance of the pool. The deterioration can take the form of both discolouration, where the pigment itself is bleached, and corrosion of the cured polymeric matrix which can lead to pitting, loss of gloss and eventually complete failure of the coating.

To address these concerns, pool manufacturers have turned to more chemically resistant types of gelcoat, such as those based on isophthalic acid/neopentyl glycol (Iso-NPG) unsaturated polyester base resins. However, even these are susceptible to deterioration if a sanitizer system goes off-line, the sensors become coated or corroded or the manual pool chemistry is not correctly maintained.

A further issue with unsaturated polyester gelcoats is the total time required to form a final cured gelcoat with acceptable surface finish. Unsaturated polyester gelcoat compositions are susceptible to air bubble capture if the film thickness is too high, resulting in porosity in the final gelcoat. Gelcoats are thus commonly produced by successively applying and curing several films of activated gelcoat composition until a target thickness is achieved. The total time to produce the final gelcoat is thus affected both by the number of individual films required and the curing time required before the next film can be applied.

Vinyl ester coatings are used in industrial applications where high chemical resistance is required. Unfortunately, these coatings weather badly (yellow/chalk) when exposed to external conditions. Furthermore, switching to a completely different resin system is not desirable, as existing infrastructure (e.g. pool production facilities and equipment), industry knowledge and supply chains are designed for the use of unsaturated polyester resin systems. It is thus preferable that high chemical resistance pool gelcoats should continue to use an unsaturated polyester as the base resin.

There is therefore an ongoing need for new gelcoat compositions which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a gelcoat composition for coating a sanitised water pool, the composition comprising: curable polymeric components comprising: (i) an unsaturated polyester base resin and (ii) a polyester-polyurethane prepolymer, wherein the polyester-polyurethane prepolymer is terminally functionalised with polymerizable ethylenically unsaturated functional groups; and reactive diluent, wherein the unsaturated polyester base resin is present in an amount of greater than 50 wt. % of the curable polymeric components, and wherein the polyester-polyurethane prepolymer is present in an amount of no more than 25 wt. % of the gelcoat composition.

In some embodiments, the polyester-polyurethane prepolymer is present in an amount of no more than 20 wt. % of the gelcoat composition, such as no more than 15 wt. % of the gelcoat composition.

The inventors have surprisingly found that the inclusion of relatively small amounts of the polyester-polyurethane prepolymer of the invention in an unsaturated polyester based gelcoat formulation is able to provide a very significant protective effect to the resultant cured gelcoat, even under bleaching conditions where a conventional gelcoat conventionally formulated with the same unsaturated polyester base resin would be subject to significant discolouration and physical degradation. The polyester-polyurethane prepolymer may be (1) blended throughout the gelcoat liquid matrix together with the unsaturated polyester base resin and reactive diluent, (2) added as a coating on decorative particulates dispersed in the gelcoat composition, or both (1) and (2).

Without wishing to be bound by any theory, in the case of (1) the resultant hardened matrix is synergistically protected against corrosion even when the residues of the polyester-polyurethane prepolymer are present in very small amounts relative to those of the polyester base resin. In the case of (2), the coating remains associated with the decorative particles after curing such that a strong protective effect against discoloration or other damage to the particulates is provided even though the residues of the polyester-polyurethane prepolymer are present in extremely low amounts relative to the overall gelcoat composition.

In some embodiments of the first aspect, the polyester-polyurethane prepolymer comprises one or more residues of a polyester diol, wherein the polyester diol is a reaction product of at least one aliphatic diol and at least one aliphatic dicarboxylic acid or anhydride thereof.

The aliphatic dicarboxylic acid or anhydride thereof may comprise an ethylenically unsaturated aliphatic diacid or anhydride thereof. The ethylenically unsaturated aliphatic diacid or anhydride thereof may be selected from the group consisting of tetrahydro phthalic anhydride, maleic anhydride, maleic acid and fumaric acid. In some embodiments it is tetrahydro phthalic anhydride.

The aliphatic diol may comprise one primary hydroxyl group and one secondary hydroxyl group. The aliphatic diol may be selected from the group consisting of propylene glycol, 1,2-butane diol and 1,3-butane diol. In some embodiments it is propylene glycol.

In some embodiments, at least 80 wt. %, or at least 90 wt. %, or substantially 100 wt. %, of the polyester diol is a reaction product of two molecules of the aliphatic diol and one molecule of the aliphatic dicarboxylic acid or anhydride thereof.

In some embodiments of the first aspect, the polyester-polyurethane prepolymer comprises residues of at least one aliphatic diisocyanate. The aliphatic diisocyanate may be selected from the group consisting of 4,4′-dicyclohexylmethane diisocyanate, isophorone diisocyanate and hexamethylene diisocyanate. In some embodiments it is 4,4′-dicyclohexylmethane diisocyanate.

In some embodiments of the first aspect, the polymerizable ethylenically unsaturated functional groups comprise (meth)acrylate groups.

In some embodiments of the first aspect, the polyester-polyurethane prepolymer comprises terminal residues of at least one end-capping molecule comprising one polymerizable ethylenically unsaturated functional group and one isocyanate-reactive functional group. The end-capping molecule may be a hydroxyalkyl(meth)acrylate, for example selected from the group consisting of a hydroxypropylmethacrylate and a hydroxybutylmethacrylate.

In some embodiments of the first aspect, the polyester-polyurethane prepolymer comprises diisocyanate residues and polyester diol residues in a mol ratio of between 6:5 and 2:1, such as between 4:3 and 2:1.

In some embodiments of the first aspect, the polyester-polyurethane prepolymer is a reaction product of a reaction sequence comprising: (a) reacting at least one aliphatic diol and at least one aliphatic dicarboxylic acid or anhydride thereof to produce a polyester diol; (b) reacting the polyester diol with at least one aliphatic diisocyanate to produce a polyester-polyurethane diisocyanate; and (c) reacting the polyester-polyurethane diisocyanate with at least one end-capping molecule comprising one polymerizable ethylenically unsaturated functional group and one isocyanate-reactive functional group to produce the polyester-polyurethane prepolymer.

In some embodiments of the first aspect, at least a portion of the polyester-polyurethane prepolymer is blended with the reactive diluent and the unsaturated polyester base resin.

In some embodiments of the first aspect, the gelcoat composition further comprises decorative particles, such as a pigment and/or glitter. At least a portion of the polyester-polyurethane prepolymer may be present in a coating on the decorative particles.

In some embodiments of the first aspect, the unsaturated polyester base resin comprises an Iso-NPG base resin.

In accordance with a second aspect the invention provides a polyester-polyurethane prepolymer for use in a gelcoat composition, the polyester-polyurethane prepolymer comprising: one or more residues of a polyester diol, wherein the polyester diol is a reaction product of at least one aliphatic diol and at least one aliphatic dicarboxylic acid or anhydride thereof; and residues of at least one aliphatic diisocyanate, wherein the polyester-polyurethane prepolymer is terminally functionalised with polymerizable ethylenically unsaturated functional groups, and wherein at least 80 wt. % of the polyester diol is a reaction product of two molecules of the aliphatic diol and one molecule of the aliphatic dicarboxylic acid or anhydride thereof.

In some embodiments of the second aspect, the polyester-polyurethane prepolymer comprises diisocyanate residues and polyester diol residues in a mol ratio of between 4:3 and 2:1.

In some embodiments of the second aspect, the aliphatic diol comprises one primary hydroxyl group and one secondary hydroxyl group. The aliphatic diol may be selected from the group consisting of propylene glycol, 1,2-butane diol and 1,3-butane diol. In some embodiments it is propylene glycol.

In some embodiments of the second aspect, the aliphatic dicarboxylic acid or anhydride thereof comprises an ethylenically unsaturated aliphatic diacid or anhydride thereof. The ethylenically unsaturated aliphatic diacid or anhydride thereof may be selected from the group consisting of tetrahydro phthalic anhydride, maleic anhydride, maleic acid and fumaric acid. In some embodiments it is tetrahydro phthalic anhydride.

In some embodiments of the second aspect, the aliphatic diisocyanate is selected from the group consisting of 4,4′-dicyclohexylmethane diisocyanate, isophorone diisocyanate and hexamethylene diisocyanate. In some embodiments it is 4,4′-dicyclohexylmethane diisocyanate.

In some embodiments of the second aspect, the polymerizable ethylenically unsaturated functional groups comprise (meth)acrylate groups.

In some embodiments of the second aspect, the polyester-polyurethane prepolymer comprises terminal residues of an end-capping molecule comprising one polymerizable ethylenically unsaturated functional group and one isocyanate-reactive functional group. The end-capping molecule may be a hydroxyalkyl(meth)acrylate, for example selected from the group consisting of a hydroxypropylmethacrylate and a hydroxybutylmethacrylate.

In accordance with a third aspect the invention provides a polyester-polyurethane prepolymer comprising molecules having a structure according to Formula 3-1 or Formula 3-2:

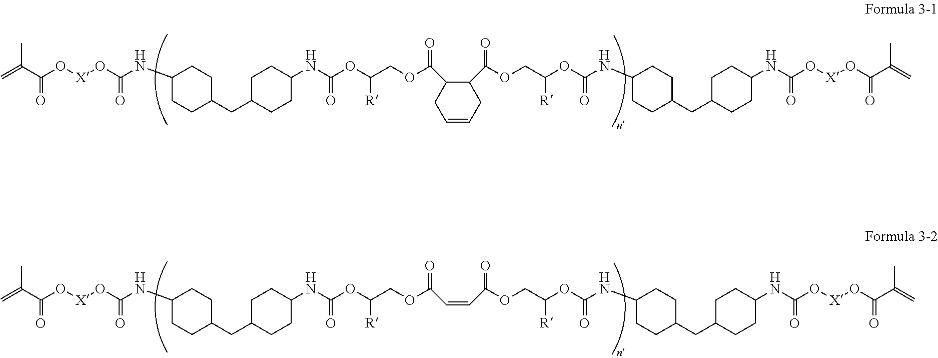

wherein each X′ is independently a C₃-C₆ alkylene group; wherein each R′ is independently methyl or ethyl; and wherein the average value of n′ in the molecules is between 1 and 5.

In some embodiments of the third aspect, each X′ is a propanediyl or a butanediyl and each R′ is methyl.

In some embodiments of the third aspect, the average value of n′ in the molecules is between 1.5 and 2.

In accordance with a fourth aspect the invention provides a coated particulate for use in a gelcoat composition, the coated pigment comprising decorative particles coated with a curable resin composition comprising a polyester-polyurethane prepolymer, wherein the polyester-polyurethane prepolymer is terminally functionalised with polymerizable ethylenically unsaturated functional groups.

In some embodiments of the fourth aspect, the decorative particles comprise pigment particles and/or glitter. The decorative particles may comprise pigment particles comprising cobalt aluminate spinel.

In some embodiments of the fourth aspect, the curable resin composition comprises a multifunctional reactive monomer, such as a multifunctional (meth)acrylate, for example a trifunctional propoxylated (meth)acrylate. Glycerol propoxylate triacrylate and trimethylolpropane propoxylate triacrylate are suitable examples.

In some embodiments of the fourth aspect, the polyester-polyurethane prepolymer comprises one or more residues of a polyester diol, wherein the polyester diol is a reaction product of at least one aliphatic diol and at least one aliphatic dicarboxylic acid or anhydride thereof. The aliphatic dicarboxylic acid or anhydride thereof may comprise an ethylenically unsaturated aliphatic diacid or anhydride thereof. The aliphatic diol may comprise one primary hydroxyl group and one secondary hydroxyl group. At least 80 wt. % of the polyester diol may be a reaction product of two molecules of the aliphatic diol and one molecule of the aliphatic dicarboxylic acid or anhydride thereof.

In some embodiments of the fourth aspect, the polyester-polyurethane prepolymer comprises residues of at least one aliphatic diisocyanate.

In some embodiments of the fourth aspect, the polymerizable ethylenically unsaturated functional groups comprise (meth)acrylate groups.

In some embodiments of the fourth aspect, the polyester-polyurethane prepolymer comprises terminal residues of at least one end-capping molecule comprising one polymerizable ethylenically unsaturated functional group and one isocyanate-reactive functional group.

In some embodiments of the fourth aspect, the polyester-polyurethane prepolymer comprises diisocyanate residues and polyester diol residues in a mol ratio of between 4:3 and 2:1.

In accordance with a fifth aspect the invention provides a gelcoat composition for coating a sanitised water pool, comprising a polyester-polyurethane prepolymer according to any of the embodiments disclosed herein.

In accordance with a sixth aspect the invention provides a gelcoat composition for coating a sanitised water pool, comprising a coated particulate according to any of the embodiments disclosed herein.

In accordance with a seventh aspect, the invention provides a method of producing a pool, the method comprising: activating a gelcoat composition according to any of the embodiments disclosed herein to form an activated gelcoat composition; applying the activated gelcoat composition to a pool mould or pool wall substrate; and curing the activated gelcoat composition to produce a gelcoat for the internal walls of a pool.

In some embodiments of the seventh aspect, the activated gelcoat composition is sprayed onto the mould or pool wall.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### DETAILED DESCRIPTION

### Gelcoat Compositions

The present invention relates to a gelcoat composition for coating a sanitised water pool. The composition comprises curable polymeric components including: (i) an unsaturated polyester base resin and (ii) a polyester-polyurethane prepolymer, wherein the polyester-polyurethane prepolymer is terminally functionalised with polymerizable ethylenically unsaturated functional groups; and reactive diluent. The unsaturated polyester base resin is present in an amount of greater than 50 wt. % of the total curable polymeric components. The polyester-polyurethane prepolymer is generally present as a minor component of the gelcoat composition, such as an amount of no more than 25 wt. % of the gelcoat composition.

As used herein, a curable polymeric component refers to a polymer precursor (or prepolymer) which is capable of curing into a hardened, high molecular weight polymer, but which already contains a sequence of repeat units prior to the curing reaction. It will be appreciated that a curable polymeric component is not itself necessarily a high molecular weight polymer and includes oligomeric prepolymers.

The curable polymeric components include an unsaturated polyester base resin. As used herein, a base resin refers to the main (i.e. most abundant) class of curable polymeric resin components present in the gelcoat. Unsaturated polyester resins are a well-known class of thermosetting moulding resins, produced by condensation of polyols such as diols (or equivalents such as epoxides) with polyacids such as di-acids (or equivalents such as anhydrides) to form the prepolymer. A portion of the polyacids are unsaturated, such that the relatively low molecular weight polyester resin components can be cross-linked, thereby curing the resin into a hardened thermoset. Suitable unsaturated diacids/anhydrides which provide the cross-linking sites include maleic acid and fumaric acid. Common saturated diacids/anhydrides include phthalic acid, phthalic anhydride, isophthalic acid, and terephthalic acid. Common diols include glycols such as ethylene glycol, 1,2-propylene glycol and neopentyl glycol.

Unsaturated polyester base resins are well-known and commercially available materials for use in gelcoats for chlorinated pools, and any such base resins can be used in the compositions of the present invention. In some embodiments, the base resin prepolymer includes residues of isophthalic acid, which provide enhanced chemical stability compared to the more conventional diacid precursor phthalic acid (or phthalic anhydride). In some embodiments, the base resin includes diol residues of neopentyl glycol, which provides enhanced chemical stability compared to more conventional diol precursors such as propylene glycol or ethylene glycol. In some embodiments, the base resin includes residues of both isophthalic acid and neopentyl glycol. Such resins, known in the industry as Iso-NPG resins, are considered state of the art for sanitised pool applications due to their enhanced resistance to chemical degradation and weathering.

While the present invention has been demonstrated to provide further advancements in the chemical resistance of Iso-NPG gelcoats and to improve the cure characteristics of such resins, it is not excluded that the unsaturated polyester base resin may be of an inferior grade, such as an Ortho-NPG resin, or a base resin which by itself does not meet minimum requirements for use in chlorinated water applications. The addition of a polyester-polyurethane prepolymer according to the invention may advantageously upgrade the performance of such base resins, thereby making them suitable for use in pool gelcoats.

Unsaturated polyester base resins are generally formulated together with a reactive diluent comprising one or more vinyl monomers. The reactive diluent modulates the viscosity of the resin to make it suitably workable and applicable, and the monomer(s) co-polymerise with the unsaturated functionalities of the base resin during curing to cross-link the polymer and form a hardened network. The monomer is often styrene, but the reactive diluent may also or alternatively contain other vinyl monomers such as vinyl toluene, vinyl acetate, methyl methacrylate and allyl ethers. Multifunctional vinyl monomers may also be included in the composition.

When applied to a mould or other substrate, gelcoat compositions generally contain additives to induce and/or accelerate curing. These additives may include catalysts or accelerators such as a cobalt salt (e.g. naphthenate or octoate) or an aromatic tertiary amine, and initiators such as a peroxide (e.g. methyl ethyl ketone peroxide, benzoyl peroxide, and acetylacetone peroxide). Some or all of these curing additives may be blended into the gelcoat composition just before application.

The gelcoat composition may also include particulate additives, including pigments, glitter, particulate polymeric chips (either thermoset or thermoplastic), antimicrobial agents, fumed silica and fillers. As will be described in greater detail hereafter, these particulates may be in some embodiments be coated with resin coatings which include the polyester-polyurethane prepolymers of the invention.

The gelcoat composition may comprise an inhibitor to inhibit premature cross-linking reactions. The inhibitor may be, for example, hydroquinone.

In some embodiments, the polyester base resin is present in an amount of at least 30 wt. %, such as at least 40 wt. %, or at least 50 wt. % of the gelcoat composition. In some embodiments, the polyester base resin may comprise greater than 60 wt. %, or greater than 70 wt. %, or greater than 80 wt. %, or greater than 90 wt. % of the total curable polymeric components in the gelcoat, including the unsaturated polyester base resin, the polyester-polyurethane prepolymers of the invention and any other curable polymeric components.

The curable polymeric components of the gelcoat compositions of the invention include a polyester-polyurethane prepolymer which is terminally functionalised with polymerizable ethylenically unsaturated functional groups. The polyester-polyurethane prepolymer is present in an amount of no more than 25 wt. % of the gelcoat composition.

In some embodiments, the polyester-polyurethane prepolymer is present in an amount of no more than 20 wt. %, or no more than 15 wt. %, or no more than 10 wt. %, of the gelcoat composition. The inventors have found that amounts of only about 7 wt. % of a terminally-unsaturated polyester-polyurethane prepolymer blended with a conventional Iso-NPG gelcoat provide enhanced protection under extremely harsh conditions, i.e. to chloride levels far in excess of standard industry tests for bleaching resistance.

In some embodiments, at least a portion of the polyester-polyurethane prepolymer is blended together and in solution with the curable polymeric components, including the unsaturated polyester base resin, throughout the gelcoat composition. Without wishing to be bound by any theory, it is believed that that the ethylenically unsaturated functional groups of the polyester-polyurethane prepolymer are co-polymerised together with the unsaturated groups of the polyester base resin and the reactive diluent during curing. The polyester-polyurethane prepolymer is thus incorporated throughout the polymeric matrix of the cured gelcoat. Surprisingly, the inventors have found that this provides a strong protective effect against chemically induced degradation even when the polymerised polyester-polyurethane prepolymer is present as only a minor component of the cured gelcoat. The polyester-polyurethane prepolymer present in this form may be present in an amount of between 1 and 25 wt. % of the gelcoat composition, for example between 5 and 20 wt. %.

In some embodiments, at least a portion of the polyester-polyurethane prepolymer is present in a curable coating on particulate additives, in particular decorative particulates such as pigment particles or glitter, dispersed in the gelcoat composition. The coating may also comprise other curable components, for example a multifunctional reactive monomer such as glycerol propoxylate triacrylate (GPTA) or trimethylol propoxylate triacrylate (TPTA). Without wishing to be bound by any theory, it is believed that a major portion of the coating remains associated with the particulate particles in the gelcoat composition, but during curing the ethylenically unsaturated functional groups of the polyester-polyurethane prepolymer co-polymerise not only with unsaturated groups present in components of the coating but also with those in the surrounding matrix. Residues of the polyester-polyurethane prepolymer are thus integrated with the cured polymeric matrix but remain located in a protective coating surrounding the particulate particles.

In some embodiments, the amount of polyester-polyurethane prepolymer added as a coating on particulate components of the gelcoat may be less than 5 wt. %, or less than 2 wt. % of the total mass of the gelcoat composition, of from 0.05 wt. % to 5 wt. %, such as from 0.1 wt. % to 1 wt. %. The inventors have found that inclusion of the polyester-polyurethane prepolymer of the invention as a pigment coating can provide a very substantial protective effect against pigment bleaching and discolouration even when the polyester-polyurethane prepolymer is present as only a very minor component of the overall gelcoat composition. As little as 0.3 wt. % polyester-polyurethane prepolymer, when added as a coating on a cobalt aluminate spinel pigment, was found sufficient to protect a cured gelcoat from any visible discoloration when subjected to a standard industry test for bleaching resistance.

In some embodiments, a portion of the total polyester-polyurethane prepolymer is blended together with the curable polymeric components throughout the gelcoat composition (as described above), and another portion of the total polyester-polyurethane prepolymer is present in a coating on particulate additives, such as pigment particles (as described above). This mode provides the combined advantages of both effects disclosed herein, i.e. by protecting the polymeric matrix from degradation and providing a protective coating surrounding the particulates dispersed in the matrix.

In some embodiments, the gelcoat composition comprises: the curable polymeric components in an amount of from 30 wt. % to 75 wt. % (such as 40 wt. % to 70 wt. %) of the gelcoat composition; the reactive diluent in an amount of from 25 wt. % to 65 wt. % (such as 30 wt. % to 60 wt. %) of the gelcoat composition; and optionally, decorative particles in an amount of from 1 wt. % to 30 wt. % (such as 2 wt. % to 15 wt. %) of the gelcoat composition.

In some embodiments, the gelcoat composition comprises: the curable polymeric components in an amount of from 30 wt. % to 75 wt. % (such as 40 wt. % to 70 wt. %) of the gelcoat composition; the reactive diluent in an amount of from 25 wt. % to 65 wt. % (such as 30 wt. % to 60 wt. %) of the gelcoat composition; and optionally, decorative particles in an amount of from 1 wt. % to 30 wt. % (such as 2 wt. % to 15 wt. %) of the gelcoat composition, wherein the gelcoat composition comprises the polyester-polyurethane prepolymer, blended with the unsaturated polyester base resin and reactive diluent, in an amount of from 1 wt. % to 25 wt. % (such as 5 wt. % to 20 wt. %) of the gelcoat composition.

In some embodiments, the gelcoat composition comprises: the curable polymeric components in an amount of from 30 wt. % to 74 wt. % (such as 40 wt. % to 68 wt. %) of the gelcoat composition; the reactive diluent in an amount of from 25 wt. % to 65 wt. % (such as 30 wt. % to 58 wt. %) of the gelcoat composition; and decorative particles in an amount of from 1 wt. % to 30 wt. % (such as 2 wt. % to 15 wt. %) of the gelcoat composition, wherein the gelcoat composition comprises the polyester-polyurethane prepolymer, present in a coating on the decorative particles, in an amount of from 0.05 wt. % to 5 wt. % (such as 0.1 wt. % to 1 wt. %) of the gelcoat composition.

In some embodiments, the gelcoat composition comprises: the curable polymeric components in an amount of from 30 wt. % to 74 wt. % (such as 40 wt. % to 68 wt. %) of the gelcoat composition; the reactive diluent in an amount of from 25 wt. % to 65 wt. % (such as 30 wt. % to 58 wt. %) of the gelcoat composition; and decorative particles in an amount of from 1 wt. % to 30 wt. % (such as 2 wt. % to 15 wt. %) of the gelcoat composition, wherein the gelcoat composition comprises the polyester-polyurethane prepolymer, blended with the unsaturated polyester base resin and reactive diluent, in an amount of from 1 wt. % to 24.95 wt. % (such as 5 wt. % to 20 wt. %) of the gelcoat composition and wherein the gelcoat composition further comprises the polyester-polyurethane prepolymer, present in a coating on the decorative particles, in an amount of from 0.05 wt. % to 5 wt. % (such as 0.1 wt. % to 1 wt. %) of the gelcoat composition.

### Polyester-Polyurethane Prepolymer

As previously disclosed herein, the gelcoat composition includes a polyester-polyurethane prepolymer which is terminally functionalised with polymerizable ethylenically unsaturated functional groups.

As used herein, a polyester-polyurethane prepolymer is an alternating copolymer comprising segments linked by a plurality of carbamate (urethane) groups and including at least one polyester segment. A polyester-polyurethane prepolymer generally has a segmented structure obtainable by the reaction of a polyol component comprising or consisting of a polyester polyol, preferably a polyester diol, with a poly-isocyanate component, preferably a diisocyanate.

As used herein, a polyester polyol is a molecule having at least two internal ester linkages, i.e. —C(═O)—O— and at least two terminal hydroxy groups, i.e. —OH, where the molecule has a structure obtainable by a condensation reaction between a polyol (preferably a diol) with a polyacid (preferably a di-acid or an equivalent such as an anhydride). Preferably the polyester polyol is a linear diol molecule obtained by a condensation reaction between a diol and a diacid or anhydride thereof.

As used herein, a polymerizable ethylenically unsaturated functional group is a functional group comprising a carbon-carbon double bond capable of polymerising and/or copolymerising with other polymerizable ethylenically unsaturated functional groups to form a polymer having an extended alkane ( . . . —C—C—C—C—C—. . . ) backbone chain. Suitable polymerizable ethylenically unsaturated functional groups include those well known in the art of polymer chemistry, and in particular those which contain a polymerizable vinyl or vinylidene group. As used herein, a “vinyl group” is a monovalent group having the structure —CH═CH₂. As used herein, a “vinylidene group” is a monovalent group having the structure —CR″═CH₂ wherein R″ is an organyl group, such as methyl (Me).

The polyester-polyurethanes of the invention typically have a polymerizable ethylenically unsaturated functional group at each terminus of the polymeric chain.

In some embodiments, the polymerizable ethylenically unsaturated functional groups are selected from the group consisting of the acryloyl group, i.e. —C(═O)CH═CH₂, the alkyl acryloyl group, i.e. —C(═O)CR¹═CH₂ where R¹ is an alkyl group (preferably Me), a vinyl group such as vinyl-aryl or vinyl ether and an allyl group such as allyl ether.

In some embodiments, the polyester-polyurethane prepolymers are terminally functionalised with (meth)acrylate groups. As used herein, a “(meth)acrylate” includes in the alternative both an acrylate and a methylacrylate. In some embodiments, the polyester-polyurethane prepolymers are terminally functionalised with methacrylate groups.

Without wishing to be bound by any theory, the terminal (i.e. chain ending) ethylenically unsaturated functional groups polymerise with each other and/or other unsaturated functionalities present in the gelcoat composition, including those of the unsaturated polyester base resin, during curing of the gelcoat. The polymerised terminal functionality assists to prevent degradation by stabilising the polymer matrix against chemical attack, which is believed to initiate preferentially at the chain ends. Morever, the polyester urethane, even when incorporated into a cured polyester matrix at low concentrations, is believed to act as a block to the chemical “unzipping” of the polymer matrix during chemical attack. Degradation may start to occur by attacks on the ester linkage, but is stopped by the chemical resistance of the urethane groups further down the polymer chains.

In some embodiments, the polyester-polyurethane prepolymer comprises one or more residues of a polyester diol. The polyester diol may be a reaction product of at least one aliphatic diol and at least one aliphatic dicarboxylic acid or anhydride thereof.

In some embodiments, the aliphatic dicarboxylic acid or anhydride thereof comprises or consists of an ethylenically unsaturated aliphatic diacid or anhydride thereof. Advantageously, the resultant polyester-polyurethane chains thus contain internal ethylenically unsaturated functionalities in the polyester segment(s) which are capable of participating in curing reactions analogous to those of the unsaturated polyester base resin. Without wishing to be bound by any theory, the combination of both terminal and internal polymerizable functionalities in the polyester-polyurethane is considered to impart particularly favourable properties of chemical resistance to the cured gelcoat.

The ethylenically unsaturated aliphatic diacid or anhydride may be selected from the group consisting of tetrahydro phthalic anhydride, maleic anhydride, maleic acid and fumaric acid. In some embodiments, the ethylenically unsaturated aliphatic diacid or anhydride is selected from maleic anhydride and tetrahydro phthalic anhydride. In some embodiments, the ethylenically unsaturated aliphatic diacid or anhydride is tetrahydro phthalic anhydride.

In some embodiments, the aliphatic diol comprises or consists of diols having one primary hydroxyl group and one secondary hydroxyl group. For example, the aliphatic diol may be selected from the group consisting of propylene glycol (i.e. 1,2-propane diol), 1,2-butane diol and 1,3-butane diol. In some embodiments, the aliphatic diol is propylene glycol.

The selection of an aliphatic diol having one primary and one secondary hydroxyl group as precursor to the polyester diol is considered advantageous due to the different reactivities of the two hydroxyls. This allows the stoichiometry of the polyester diol (and thus the segments in the resulting polyester-polyurethane prepolymer) to be accurately controlled. In particular, it favours the formation of a polyester diol which comprises only two ester linkages, i.e. which is a reaction product of two molecules of the aliphatic diol (reacting at the primary alcohol only) with one molecule of the aliphatic dicarboxylic acid or anhydride thereof. The difference in selectivity between the two hydroxyls thus facilitates a high selectivity to the desired monomeric polyester (with two ester linkages) in preference to oligomeric polyesters (with three or more ester linkages) where the internal diol residues are reacted with two isocyanate groups.

In some embodiments, at least 80 wt. %, or at least 90 wt. %, or substantially 100 wt. % of the polyester diol is a reaction product of two molecules of aliphatic diol and one molecule of aliphatic dicarboxylic acid/anhydride. Because the monomeric polyester diol component has a low molecular weight, the use of a polyester diol comprising mainly or entirely the monomeric component ensures that the concentration of urethane groups in the polyester-polyurethane prepolymer can be maximised. It is considered that a high density of urethane linkages, relative to ester linkages, may contribute to the advantageous stability provided by the polyester-polyurethane to the cured gelcoat.

The polyester diol may comprise, or consist of, molecules having a structure selected from Formulae 1-1, 1-2 and 1-3, obtainable by reaction of a 1,2-alkane diol with tetrahydro phthalic anhydride, maleic anhydride or fumaric acid respectively:

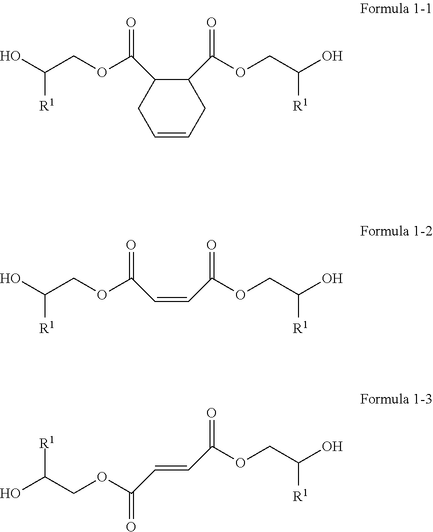

In Formulae 1-1, 1-2 and 1-3, each R¹ is independently selected an alkyl, for example a C₁-C₆ alkyl such as methyl.

In some embodiments, the polyester-polyurethane prepolymer comprises residues of at least one aliphatic diisocyanate. Aliphatic diisocyanates are preferred over aromatic diisocyanates due to the propensity of polyurethanes containing aromatic diisocyanate residues to yellow upon UV exposure. In some embodiments, the polyester-polyurethane prepolymer is thus free of aromatic diisocyanate residues. The aliphatic diisocyanate may be selected from the group consisting of 4,4′-dicyclohexylmethane diisocyanate, isophorone diisocyanate and hexamethylene diisocyanate. In some embodiments, the aliphatic diisocyanate comprises, or consists of, 4,4′-dicyclohexylmethane diisocyanate, which is sold under the trade name Desmodur W. This product was found to react with polyester diols at relatively low temperatures compared to some other diisocyanates, thus reducing the risk of unwanted side reactions.

The polyester-polyurethane prepolymer has a degree of polymerisation, n, which herein represents the average number of polymerised polyol residues in the prepolymer molecules. In some embodiments, the value of n is between 1 and 5, such as between 1 and 3, or between 1.5 and 2. The polyester-polyurethane prepolymer may thus comprise diisocyanate residues and polyester diol residues in a mol ratio of between 6:5 and 2:1, or between 4:3 and 2:1. An n value of between 1.5 and 2, in combination with the selection of a monomeric polyester diol as described herein, has been found to provide a suitable average molecular weight, viscosity and density of urethane linkages for the polyester-polyurethane of the invention. The value of n, and the molecular weight distribution of the prepolymer, can be manipulated by controlling the molar ratio of the di-isocyanate precursor to the diol precursor and the order of addition as will be explained in greater detail hereafter.

The polyester-polyurethane prepolymer may have a desired average molecular weight and/or molecular weight distribution, for example to meet regulatory and/or performance requirements. In some embodiments, the polyester-polyurethane prepolymer may have an Mₙ of greater than 1000 g/mol (where Mₙ is the number average molecular weight as measured by gel permeation chromatography). In some embodiments, the polyester-polyurethane prepolymer may have an Mₙ of less than 2000 g/mol, or less than 1500 g/mol, so as to avoid excessive viscosities. The value of Mₙ can be tailored based on the selection of precursors, including preferably a monomeric polyester diol, the molar ratio of the di-isocyanate precursor to the diol precursor and the order of addition of the reagents.

In some embodiments, the polyester-polyurethane prepolymer comprises terminal residues of end-capping molecules comprising one polymerizable ethylenically unsaturated functional group and one isocyanate-reactive functional group. The polyester-polyurethane prepolymer is thus produced by reacting an isocyanate-terminated polyester-polyurethane prepolymer with the end-capping molecules.

Isocyanate-reactive functional groups are well-known in the art of polymer chemistry. They include hydroxy groups and amine groups, which thus form urethane linkages and urea linkages between the polyester-polyurethane prepolymer and the terminal ethylenically unsaturated groups respectively.

In some embodiments, the end-capping molecule is a hydroxyalkyl(meth)acrylate, for example selected from the group consisting of a hydroxypropylmethacrylate and a hydroxybutylmethacrylate.

In some embodiments, the polyester-polyurethane prepolymer comprises molecules having (1) one or more residues of a polyester diol, wherein the polyester diol is a reaction product of at least one aliphatic diol and at least one aliphatic dicarboxylic acid or anhydride thereof, and (2) residues of at least one aliphatic diisocyanate, wherein the polyester-polyurethane prepolymer is terminally functionalised with polymerizable ethylenically unsaturated functional groups, and wherein at least 80 wt. % of the polyester diol is a reaction product of two molecules of the aliphatic diol and one molecule of the aliphatic dicarboxylic acid or anhydride thereof.

Such polyester-polyurethane prepolymers have the following advantages:
the aliphatic nature of the prepolymer, including both polyester diol residues and diisocyanate residues, protects against weathering/UV degradation;
the high proportion of monomeric polyester diol (i.e. including only two ester linkages) provides a high density of chemically stable urethane linkages relative to less stable ester linkages; and
The terminal ethylenically unsaturated functional groups, when polymerised during curing, assist to prevent degradation by stabilising the polymer matrix against chemical attack which is believed to initiate preferentially at the chain ends.

In some such embodiments, substantially all of the polyester diol is monomeric, i.e. a reaction product of two molecules of the aliphatic diol and one molecule of the aliphatic dicarboxylic acid or anhydride thereof.

In some such embodiments, the polyester-polyurethane prepolymer comprises diisocyanate residues and polyester diol residues in a mol ratio of between 4:3 and 2:1. This ratio, corresponding to an average degree of polymerisation of between 1 and 3, may provide a molecular weight and/or viscosity particularly suitable for use in the gelcoat compositions of the invention.

In some such embodiments, the aliphatic diol comprises one primary hydroxyl group and one secondary hydroxyl group. The aliphatic diol may be selected from the group consisting of propylene glycol, 1,2-butane diol and 1,3-butane diol.

In some such embodiments, the aliphatic dicarboxylic acid or anhydride thereof comprises an ethylenically unsaturated aliphatic diacid or anhydride thereof. The ethylenically unsaturated aliphatic diacid or anhydride thereof may be selected from the group consisting of tetrahydro phthalic anhydride, maleic anhydride, maleic acid and fumaric acid.

In some such embodiments, the aliphatic diisocyanate is selected from the group consisting of 4,4′-dicyclohexylmethane diisocyanate, isophorone diisocyanate and hexamethylene diisocyanate.

In some such embodiments, the polyester-polyurethane prepolymer comprises terminal residues of an end-capping molecule comprising one polymerizable ethylenically unsaturated functional group and one isocyanate-reactive functional group. The end-capping molecule may be a hydroxyalkyl(meth)acrylate.

In some embodiments, the polyester-polyurethane prepolymer comprises molecules having a structure according to Formula 2-1:

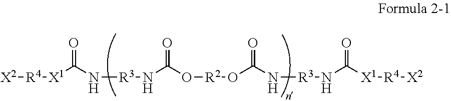

In Formula 2-1: each R² is an aliphatic polyester segment, each R³ is an aliphatic linker derived from an aliphatic diisocyanate; each R⁴ is independently a C₂-C₁₀ alkylene linker; each X¹ is independently —O— or —NH—; each X² is independently a (meth)acrylate group; and each n′ is an integer of 1 or greater.

The aliphatic polyester segment may be derived from a polyester diol precursor, which is a reaction product of one molecule of aliphatic diol and two molecules of aliphatic dicarboxylic acid or anhydride thereof. The aliphatic linker may be derived from an aliphatic diisocyanate precursor.

In some embodiments, the average value of n′ in the molecules is between 1 and 5. In some embodiments, the average value of n′ in the molecules is between 1 and 3. In some embodiments, the average value of n′ in the molecules is between 1.5 and 2.

In some embodiments, each R² in Formula 2-1 has a structure selected from Formula R²-1, Formula R²-2 and Formula R²-3:

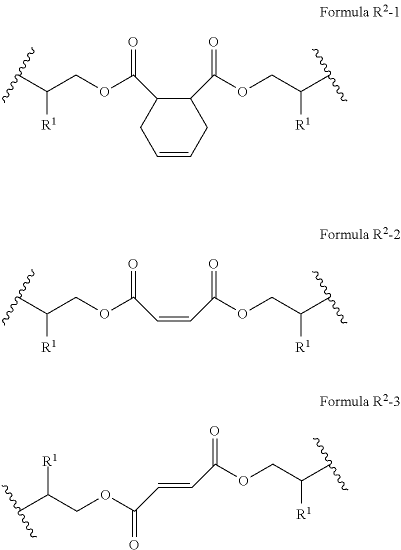

In Formulae R²-1, R²-2 and R²-3, each R¹ is independently an alkyl, for example a C₁-C₆ alkyl such as methyl.

In some embodiments, each R³ in Formula 2-1 has a structure selected from Formula R³-1, Formula R³-2 and Formula R³-3:

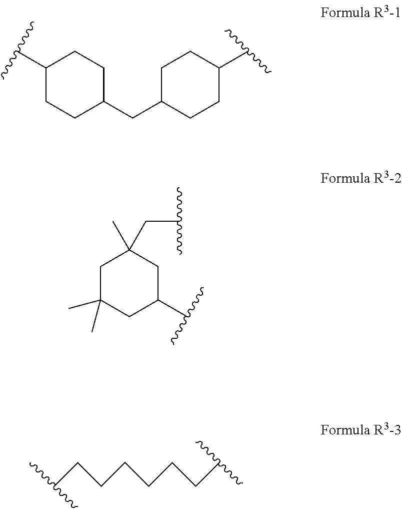 [SMILES: *C1CCC(CC2CCC(*)CC2)CC1 ; *CC1(C)CC(*)CC(C)(C)C1 ; *CCCCCC*]

In some embodiments, each R⁴ in Formula 2-1 is independently a C₃-C₆ alkylene linker, such as a propylene (e.g. 1,2-propylene) or butylene linker.

In some embodiments, each X¹ in Formula 2-1 is —O—.

In some embodiments, each X² in Formula 2-1 is a methacrylate group.

In some embodiments, the polyester-polyurethane prepolymer comprises molecules having a structure according to Formula 3-1 or Formula 3-2:

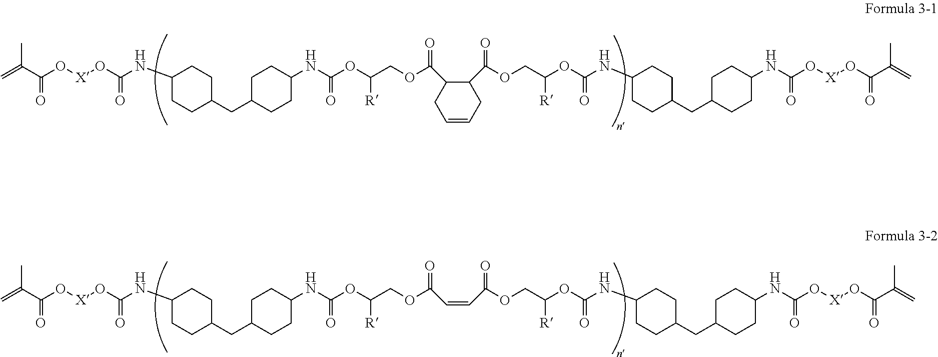

In Formulae 3-1 and 3-2, each X′ is independently a C₃-C₆ alkylene group, each R′ is independently methyl or ethyl and each n′ is an integer of 1 or greater, wherein the average value of n′ in the molecules is between 1 and 5.

In some embodiments, each X′ in Formula 3-1 and Formula 3-2 is a propanediyl or a butanediyl.

In some embodiments, each R′ in Formula 3-1 and Formula 3-2 is methyl.

In some embodiments, the average value of n′ in the molecules is between 1 and 3, or between 1.5 and 2.

### Coated Particulate

The present invention also relates to a coated particulate, in particular a coated decorative particulate suitable to be added to a gelcoat composition such as a pigment or a glitter. The coated particulate comprises particles coated with a curable resin composition comprising a polyester-polyurethane prepolymer terminally functionalised with polymerizable ethylenically unsaturated functional groups.

The polyester-polyurethane prepolymer may be the same as any of the embodiments disclosed herein in relation to the gelcoat composition of the invention.

Cured gelcoats coloured with various pigments are susceptible to unsightly discolouration when exposed to bleaching conditions. The inventors have demonstrated that use of a coated pigment, in accordance with the invention, protects the pigment itself from chemical attack and thus protects the cured gelcoat from discolouration. Thus, even a very small amount of the polyester-polyurethane prepolymer relative to the gelcoat composition as a whole can provide a substantial protective effect to the cured gelcoat when coated onto the pigment. A similar protective effect is expected for other decorative particulates such as glitter.

In some embodiments, the coated particulate comprises a coated pigment. Pigments suitable for use in decorative gelcoats are well known, and any such pigments may be present in the coated particulates of the invention. Examples of suitable pigments include cobalt aluminate spinel, titanium dioxide, carbon black, yellow oxide, red oxide, phthalo green, organic orange, isoindoline yellow and the like. A common pigment for sanitised pools is cobalt aluminate spinel, for examples Blue 214 pigment available from Shepherd, which is blue.

The coated pigment may be present in a pigment paste, where the pigment particles are dispersed in the curable resin. In some embodiments, the pigment is ground in the curable resin to produce the coated pigment. The grinding may comminute the pigment into appropriately sized particles and ensure that the surfaces of the pigment particles are well coated with the resin.

The pigment paste may comprise the pigment and curable resin in any suitable amounts provided that the curable resin is sufficient to coat the pigment particles. In some embodiments, the pigment may be present in an amount of between 10 and 60 wt. %, or between 20 and 50 wt. %, for example between 30 and 50 wt. %, of the pigment paste.

The curable resin may be a grinding resin, i.e. when the pigment is dispersed therein by grinding. Grinding resins are conventionally formulated with saturated polyester resins and have suitable properties, including viscosity, to provide acceptable pigment loading during milling, good pourability, dispersability into the gelcoat, acceptable storage drift (avoiding heavier particles separating to the bottom of the storage container), and minimising colour separation of mixed pigments in the gelcoat. Similar viscosities may be targeted for the curable resins comprising the polyester-polyurethane of the invention.

The curable resin may comprise, in addition to the polyester-polyurethane prepolymer, one or more further curable components. The further curable components may provide some or all of the following properties and functions: 1) modulating the viscosity of the resin to maintain suitable mobility during preparation of the curable resin, to facilitate coating or grinding of the particulates and/or to allow a high pigment loading, 2) good wettability of the particulates, 3) good heat resistance (since grinding generates heat), 4) providing a high flash point and low volatility to the curable resin composition, 5) good curability of its unsaturated functional groups with those of the polyester-polyurethane prepolymer, and 6) low or zero aromatic content.

In some embodiments, the further curable components comprise a multifunctional reactive monomer, such as a trifunctional reactive monomer. As used herein, a multifunctional reactive monomer refers to a monomer molecule with two or more polymerizable ethylenically unsaturated terminal functionalities. In some embodiments, the multifunctional reactive monomer is aliphatic. In some embodiments, the unsaturated terminal functionalities are attached to the monomer molecule via an alkoxylate chain, for example comprising one or more residues of propylene oxide and/or ethylene oxide. The inventors have found that such materials in combination with the polyester-polyurethane prepolymer form a coating which remains associated with the pigment particles when dispersed in a gelcoat composition.

In some embodiments, the aliphatic multifunctional reactive monomer is a multifunctional (meth)acrylate. In some embodiments, the aliphatic multifunctional reactive monomer is a multifunctional propoxylated (meth)acrylate, for example a trifunctional propoxylated (meth)acrylate.

In some embodiments, the aliphatic multifunctional reactive monomer has a structure according to Formula 4:

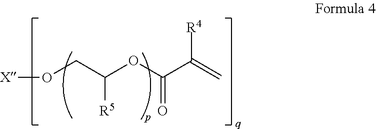

In Formula 4, q is an integer of from 2 to 6, such as 3. X″ is an aliphatic molecular core with a valency of q, for example a hydrocarbon core having the formula CₓH_{(2x+2-q)} where x is an integer of from 1 to 20. Each p is an integer of 1 or greater. Each R⁴ and R⁵ is independently H or methyl. In some embodiments each R⁵ is methyl.

In some embodiments, the curable resin comprises a trifunctional propoxylated (meth)acrylate such as glycerol propoxylate triacrylate or tri methylolpropane propoxylate triacrylate.

In some embodiments, the curable resin may comprise a wetting agent. Suitable wetting agents for dispersing pigments in resins are well known, an example being Disperbyk-115 available from BYK Additives and Instruments.

### Method of Preparing a Gelcoat Composition

The invention also relates to a method of producing a gelcoat composition. The method includes producing a polyester-polyurethane prepolymer which is terminally functionalised with polymerizable ethylenically unsaturated functional groups by reacting (i) at least one polyester diol, (ii) at least one aliphatic diisocyanate and (iii) at least one end-capping molecule comprising one polymerizable ethylenically unsaturated functional group and one isocyanate-reactive functional group, to produce the polyester-polyurethane prepolymer. The method further comprises combining the polyester-polyurethane prepolymer and an unsaturated polyester base resin together with reactive diluent. The reactive diluent may be introduced to the composition with the polyester-polyurethane prepolymer, the unsaturated polyester base resin and/or as a separate component.

The method of the invention may include an initial step of producing the polyester diol by reacting at least one aliphatic diol and at least one aliphatic dicarboxylic acid or anhydride thereof. The stoichiometry of the aliphatic diol and aliphatic dicarboxylic acid/anhydride is controlled to ensure formation of a predominantly or entirely monomeric polyester diol.

The aliphatic diol, the aliphatic dicarboxylic acid or anhydride thereof, the polyester diol, the aliphatic diisocyanate and the end-capping molecules may be according to any of the embodiments disclosed herein in relation to the gelcoat composition of the invention.

In some embodiments, the polyester diol is reacted with the at least one aliphatic diisocyanate to produce a polyester-polyurethane diisocyanate intermediate before introducing the at least one end-capping molecule. This avoids or minimises undesirable reactions such as that between one molecule of aliphatic diisocyanate and two end-capping molecules. The end-capping molecule is thus preferably only added after substantially complete reaction between the polyester diol and aliphatic diisocyanate to form the polyester-polyurethane diisocyanate. The subsequent end-capping reaction is then controlled, including via the stoichiometry of the added end-capping molecule, to ensure that residual isocyanate functionalities are reduced to a very low level.

It will be apparent to the skilled person that the degree of polymerisation of the polyester-polyurethane is generally determined by the ratio of the polyester diol and the diisocyanate, and this ratio should thus be carefully controlled. An idealised reaction between an unsaturated polyester diol (HO—R²—OH, where R₂ is an unsaturated polyester segment) and excess aliphatic di-isocyanate (OCN—R³—NCO, where R³ is an aliphatic linking group) is shown in Scheme 1.

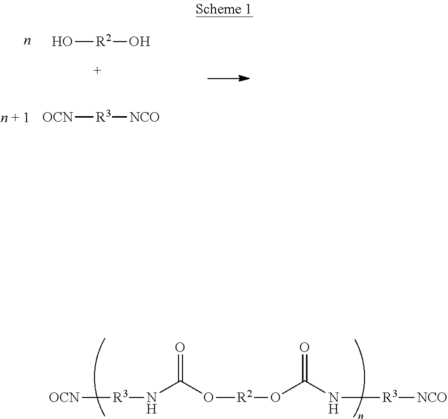

The degree of polymerisation n is thus related to the molar ratio of the di-isocyanate precursor to the diol precursor, i.e. (n+1):n, which ratio should lie in the range between 1 and 2 to ensure quantitative consumption of the reagents and exclusively isocyanate terminal groups. Where the ratio is closer to 2, the value of n will approach 1 and a low molecular weight polyester-polyurethane will be obtained. As the ratio approaches 1, the value of n will increase and high molecular weight polyester-polyurethane will be obtained. A target molecular weight can thus be obtained by controlling the molar ratio of the di-isocyanate precursor to the diol precursor.

In some embodiments, the degree of polymerisation and the order of addition of the reactants is controlled to ensure a suitable average molecular weight and/or molecular weight distribution of the polyester-polyurethane prepolymer. On one hand, it may be necessary to maintain a molecular weight above a minimum value (such as Mₙ>1000 g/mol, where Mₙ is the number average molecular weight) to meet regulatory requirements. On the other hand, it may be desirable to avoid excessive molecular weight components, for example to limit the viscosity.

The (successive) reactions between polyester diol, aliphatic diisocyanate and end-capping molecule are typically conducted in the presence of a reactive diluent. The reactive diluent may be styrene. Alternatively the reactive diluent may comprise a multifunctional reactive monomer such as GPTA or TPTA. The amount of reactive diluent may be controlled to ensure an appropriate viscosity to allow agitation and heat control during the reactions. Once the reactions are complete, further reactive diluent may be added to produce a desired final prepolymer concentration.

The urethane-forming reaction may be catalysed with conventional catalysts, for example a tin catalyst such as dibutyl tin dilaurate. The reactions should also be controlled to avoid unintended gelling of the composition by undesirable cross-linking reactions of the unsaturated ethylenically unsaturated functionalities. An inhibitor such as hydroquinone may thus be added to the reacting mixture, and the reaction conditions and selection of catalysts may also be optimised to avoid gelling reactions for any particular embodiment using routine methodologies known to the skilled person.

The polyester-polyurethane prepolymer may be introduced to the gelcoat composition in several different ways. In some embodiments, the polyester-polyurethane prepolymer, typically already diluted with a reactive diluent such as styrene, is blended with an unsaturated polyester base resin composition (also generally already diluted with a reactive diluent such as styrene). The two components, and optional further reactive diluent, are combined in ratios suitable to achieve a desired amount of polyester-polyurethane prepolymer in the gelcoat composition, in particular no more than 35 wt. % of the composition.

In some embodiments, the polyester-polyurethane prepolymer is introduced to the gelcoat composition together with a pigment or other particulate component such as glitter. The method may thus include a step of combining the polyester-polyurethane prepolymer with decorative particles to form a coated particulate, for example by grinding a pigment in a resin composition comprising the polyester-polyurethane prepolymer. The resin composition may comprise an aliphatic multifunctional reactive monomer such as GPTA or TPTA, as described herein. The coated particulate is then mixed into the gelcoat composition in a suitable amount to colour the gelcoat as required.

In some embodiments the polyester-polyurethane prepolymer is added to the gelcoat composition both (1) in liquid form to produce a matrix mixture together with the unsaturated polyester base resin in the reactive diluent, and (2) as a particulate coating.

### Method of Coating a Pool

The present invention also relates to a method of producing a pool. A gelcoat composition according to the invention is activated to form an activated gelcoat, and the activated gelcoat is then applied to a pool mould or pool wall substrate and cured to produce a cured gelcoat for the internal walls of a pool.

The pool may be any type of gelcoated pool, and in particular a pool intended to contain sanitised water. The pool may be a swimming pool, but may also be another type of pools such as an artificial pond or a water feature pool.

In some embodiments, activating the gelcoat composition comprises adding an initiator and/or a catalyst. In some embodiments, an organic peroxide initiator such as methyl ethyl ketone peroxide, benzoyl peroxide or acetylacetone peroxide is added to the gelcoat composition before and or during the application thereof to activate the gelcoat.

The activated gelcoat may be applied to the pool mould or pool wall substrate by any suitable technique or combination of techniques including spraying, rolling and brushing. Most commonly, the activated gelcoat is applied by spraying. Once applied, the activated gelcoat composition is allowed to cure to form the gelcoat. Optionally, the activated gel coat may be applied in two or more layers, allowing sufficient time between applications to allow at least partial curing of the underlying layer. Curing of the final gelcoat may be achieved simply by allowing the curing reactions to proceed at ambient temperature until the gelcoat is fully hardened. Optionally, however, curing may be conducted at elevated temperatures or the cured gelcoat may be subjected to an elevated temperature post cure step, for example at 40° C. for 16 hours.

The inventors have surprisingly found that at least some gelcoat compositions as disclosed herein provide improvements over conventional unsaturated polyester gelcoats during the application and curing steps, in addition to the advantageously enhanced chemical resistance of the final gelcoat. These include the ability to apply thicker layers of the activated gel coat composition, thus reducing the number of layers needed to form a gelcoat of desired thickness. Moreover, the low porosity and high gloss of the resultant gelcoats are attributed to favourable air release from the applied layers of activated gelcoat.

In some embodiments, the method comprises producing a pool shell on a pool mould. The mould to which the activated gelcoat composition is applied is generally treated with a release agent to facilitate the release of the final pool shell off the mould. The composition is typically applied to the top of the mould (forming the floor of the pool shell) before moving downwards to spray the walls and subsequently the edge beam of the pool.

Once the gelcoat composition has been applied to the required thickness (e.g. 0.5-1.2 mm) across the entire mould it is allowed to cure sufficiently to receive the structural backing layers. Resin and glass fibre reinforcement may then be added in several layers to form the laminate structure of the pool shell with the cured gelcoat as the innermost layer. Once the entire structure is sufficiently cured to provide structural strength, the shell can removed from the mould.

In some embodiments, the method comprises applying the activated gelcoat in situ to a pool wall substrate (including the side walls and floor) during construction of a new pool or repair of an existing pool. For example, pool walls may be constructed using a concrete base and sheet material, laminate layers of vinyl ester resin and glass fibre are overlaid and finally the activated gelcoat is added as a flowcoat. In another example, the activated gelcoat may be added to repair sections of a gelcoated pool that has failed.

The gelcoat compositions of the invention may also be used in other applications, including those with high performance requirements with regard to chemical attack and weathering. Suitable applications may include marine applications such as boat coatings, and vehicle coating applications such as truck panels, RVs and caravans, and building products such as fibreglass roof sheeting.

### EXAMPLES

The present invention is described with reference to the following examples. It is to be understood that the examples are illustrative of and not limiting to the invention described herein.

### Materials

Tetrahydro phthalic anhydride, maleic anhydride, propylene glycol, dibutyl tin dilaurate, hydroquinone, styrene, 2-hydroxy propyl methacrylate, hydroxy butyl methacrylate (90%-10% mixture of 4- and 2-hydroxybutyl isomers), hydroxyethyl methacrylate, isophorone diisocyanate, hydroxypropyl acrylate were obtained from commercial suppliers. Bis(4-isocyanatocyclohexyl)methane (Desmodur W) was obtained from Covestro.

Glycerol propoxylate triacrylate (GPTA) grade M320 and trimethylolpropane propoxylate (PO₃) triacrylate were obtained from MIWON (Korea).

Blue 214 pigment (Shepherd 214), a cobalt aluminate spinel pigment, was obtained from The Shepherd Color Company.

Progel+281S and CS1, which are clear unsaturated polyester iso-NPG gelcoats, was obtained from RF Composites. Reversol P-980 P, a clear unsaturated polyester iso-NPG gelcoat, was obtained from Luxchem. All of these compositions are diluted with styrene, and have a solids (polyester resin) content of approximately 60 wt. %.

### Example 1

A polyester diol, designated (1-1), was prepared by reacting tetrahydro phthalic anhydride (THPA) with propylene glycol (PG, 1.9 mol equivalent) as depicted in Scheme 2. The PG was added at close to, but slightly less than, the theoretical stoichiometric ratio of 2.0, thus minimising free PG in the product while ensuring that a high proportion of the desired monomeric polyester diol i.e. PG-THPA-PG, was obtained as opposed to PG-THPA-PG-THPA-PG and other oligomers. The reaction was judged complete when an acid value of less than 10 mg KOH/gm was obtained.

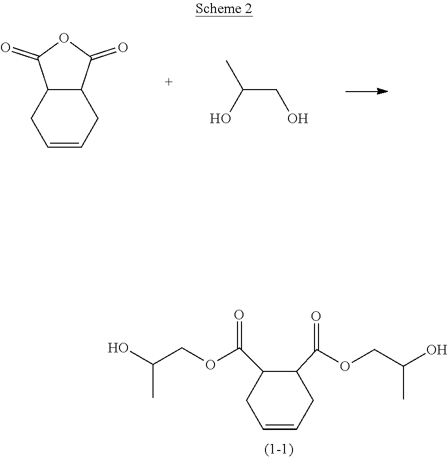

A similar polyester diol (1-2) was obtained using maleic anhydride (MA) and PG via the same methodology.

### Example 2

A resin, hereafter designated R/2-1/SM, comprising polyester-polyurethane dimethacrylate (2-1) with styrene reactive diluent (30 wt. % styrene) was prepared by the following procedure. A kettle reactor, equipped with stirrer, cooling coils and steam heating capability, was charged with bis(4-isocyanatocyclohexyl)methane (Desmodur W). Dibutyl tin dilaurate (DBTDL) (0.01 wt. %) as catalyst and hydroquinone (HQ) (0.02 wt. %) as inhibitor were added and the mixture was stirred.

Polyester diol (1-1) (0.637 mol equivalent relative to Desmodur W) was then added in stages. Initially, half of the polyester diol was added to the reactor. The reaction mixture exothermed and the temperature was controlled below 75° C. by applying cooling. Once the exotherm had subsided and the temperature dropped to 55-60° C., the remaining polyester diol was added and the reaction temperature was controlled in similar manner. During this stage, a portion of the styrene (25%) was added to the mixture with further HQ (0.01 wt. %), to maintain a viscosity suitable for agitation.

Once the exotherm has subsided and the temperature dropped to 65° C., 2-hydroxy propyl methacrylate (HPMA) (0.39 mol equivalent relative to Desmodur W) was added to the mixture. A slight excess of HMPA was thus added to ensure essentially complete reaction of the isocyanate groups. The mixture again exothermed and was controlled below 80° C. by applying cooling. During the cooling, the remaining styrene was added to bring the styrene content to 30 wt. % in the final resin product.

The polyester-polyurethane dimethacrylate (2-1) reaction product in the resin was thus produced by the reactions shown in Scheme 3, where n is calculated to be about 1.6 on average (based on the mol ratio of diisocyanate to polyester diol). The ratios of the components, and their order or addition, were selected to endure that all prepolymer components had a molecular weight above 1000 Dalton but that the resin remained sufficiently low in viscosity, with the added styrene present, to be workable. A Mₙ of 1021 Dalton was determined by gel permeation chromatography, and the viscosity of the resin was in the range of 1000 to 2000 cps.

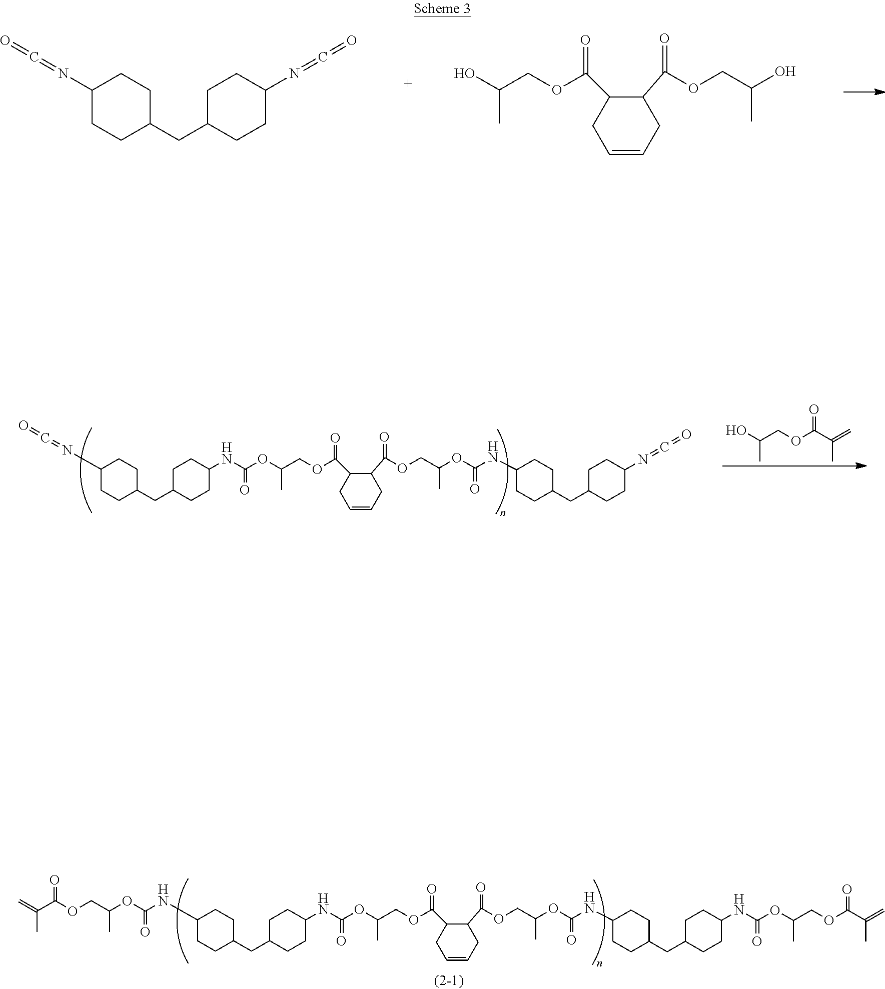

Resins with further proposed polyester-polyurethane di(meth)acrylates, having a different unsaturated polyester (1-2), a different diisocyanate (isophorone diisocyanate=IPDI) and different hydroxyalkyl(meth)acrylates (hydroxybutyl methacrylate=HBMA; hydroxyethyl methacrylate=HEMA; 2-hydroxypropyl acrylate=HPA) were investigated using analogous methodologies, as shown in Table 1.

TABLE 1

| Polyester- | | | Hydroxy- | |
|---|---|---|---|---|
| polyurethane | Polyester | | (meth) | |
| di(meth)acrylate | diol | Diisocyanate | acrylate | Observation |
| 2-1 | 1-1 | Desmodur W | HPMA | |
| 2-2 | 1-2 | Desmodur W | HPMA | Excellent polymer properties, slight colour compared to 2-1 |
| 2-3 | 1-1 | IPDI | | Higher reaction temperatures required for urethane formation; |
| | | | | leading to greater susceptibility to gelling |
| 2-4 | 1-1 | Desmodur W | HBMA | Excellent polymer properties |
| 2-5 | 1-1 | Desmodur W | HEMA | Greater susceptibility to gelling |
| 2-6 | 1-1 | Desmodur W | HPA | Greater susceptibility to gelling |

### Example 3

A resin, hereafter designated R/2-1/GPTA, containing the polyester-polyurethane dimethacrylate (2-1) in propoxylated glycerol triacrylate (GPTA) reactive diluent (33 wt. %) was prepared by the same method as example 2 but using GPTA instead of styrene. Another resin, hereafter designated R/2-1/TPTA, was prepared similarly but using trimethylolpropane propoxylate triacrylate (TMTA) reactive diluent. A further resin, hereafter designated R/2-1/DMB, was prepared with dibutylmaleate (DMB) as diluent (40 wt. % DMB).

Diluted resins with 10% and 20 wt. % polyester-polyurethane dimethacrylate (2-1) content were then prepared by adding further GPTA to the R/2-1/GPTA resin. These diluted resins are designated R/2-1/GPTA-10 and R/2-1/GPTA-20 respectively.

### Example 4

Coated pigments, hereafter P/2-1/GPTA-10 and P/2-1/GPTA-20, were prepared by dispersing Blue 214 pigment in resin R/2-1/GPTA-10 or R/2-1/GPTA-20 respectively in a milling machine, at a mass ratio of about 40 wt. % Blue 214 pigment to about 60 wt. % resin. A small amount (0.5 wt. %) of Disperbyk 115 was added as a wetting agent. The GPTA-diluted resins were found to provide excellent wetting of the pigment particles.

### Example 5

Gelcoat compositions were prepared by blending base gelcoats, polyurethane acrylate resins and coated pigments as set out in Table 2 below. For gelcoat G5-1, Blue 241 pigment was high speed dispersed in resin R/2-1/DMB at low concentration. The mixture was then blended into the Iso-NPG gelcoat to give the composition shown in Table 1. For the other gelcoat compositions, the specified components were mixed together.

TABLE 2

| | | | | | | Total amount |
|---|---|---|---|---|---|---|
| | | | | | Amount | of polyester- |
| | | | Amount of | | pigment | polyurethane |
| | | Resin | resin added | | added to | di(meth)- |
| | | added to | to gelcoat | | gelcoat | acrylate |
| Gelcoat | Base gelcoat | gelcoat | (wt. %) | Pigment | (wt. %) | (wt. %) |
| G5-1 | Progel + 281S | R/2-1/DMB | 20 | Blue 241 | 2-3 ^{a} | 20 |
| G5-2 | CS1 | — | — | P/2-1/GPTA-10 | 4.5 | c.a. 0.3 |
| G5-3 | CS1 | — | — | P/2-1/GPTA-10 | 7.5 | c.a. 0.5 |
| G5-4 | CS1 | — | — | P/2-1/GPTA-10 | 12.0 | c.a. 0.7 |
| G5-5 | CS1 | — | — | P/2-1/GPTA-10 | 17.6 | c.a. 1.0 |
| G5-6 | Reversol P-980 P | — | — | P/2-1/GPTA-10 | 10 | c.a. 0.6 |
| G5-7 | Reversol P-980 P | R/2-1/SM | 10 | — | — | c.a. 7 |
| G5-8 | Reversol P-980 P | R/2-1/SM | 6 | P/2-1/GPTA-10 | 8 ^{b} | c.a. 4.7 |
| G5-9 | Reversol P-980 P | — | — | P/2-1/GPTA-20 | 10 ^{b} | c.a. 1.2 |

^{a} based on dry pigment powder
^{b} glitter added in addition to pigment

### Example 6

Test panels were coated with the gelcoats shown in Table 2 as follows. The gelcoats are catalysed with a MEKP initiator and applied by spray application onto a toughened glass sheet that has been treated with a release agent. After the gelcoat was tack dry (doesn't leave colour on finger), which was generally after 45 minutes to 70 minutes, it was laminated with vinyl ester resin backup layers of powder bound chopped strand mat glass fibre (typically ˜5 mm thick) or with vinyl ester backup layers (3 mm thick) followed by polyester layers (to a total of 5 or 6 mm backing thickness). The laminate layers were applied by hand using brushes to dab the resin and metal rollers to consolidate the laminates and remove air. The panels were manufactured and left to cure at ambient temperatures, ensuring the temperature remained above 15° C. The panels were cured for 3 to 5 days before testing.

Comparative panels with commercially available Iso-NPG gelcoats were prepared by the same methodology. It was observed that the gelcoats containing polyester-polyurethanes provided a higher, sustained peak exotherm during curing, indicating a more rapid curing process.

### Example 7

The coated panels were subjected to bleaching test conditions as follows.

According to Australian Standard Test AS/NZS 1838-1994 titled “Swimming pools—Premoulded fibre-reinforced plastics—Design and fabrication”, an aqueous solution (1 litre) of 0.5 g Ca(CIO)₂ with a concentration of 325 ppm was prepared in a beaker, and the pH was adjusted to 6.5. The panel for testing was placed in the beaker with about half of the panel submersed in the solution. The beaker was sealed with plastic film, and placed in a water bath set to 60° C. for 18 hours. After removing the panel from the solution, a comparison was made between the portion of the panel submerged in the solution with the remainder of the panel. This test is designated as “0.5 g Ca(CIO)₂, 325 ppm Cl, 18 h, pH 6.5” in Table 3.

The AS/NZS 1838-1994 test uses relatively mild conditions and may not accurately simulate long-term exposure to actual pool environments where changes to pool equipment, chemical dosing and temperature can affect the level of sanitisation and corrosion. Therefore additional tests of higher severity have been developed to better simulate the high chlorine levels and pH levels (pH of 8 or higher) where pools with sanitising systems are particularly susceptible to failure. Bleaching tests with increased bleaching/corrosion severity were thus performed by varying the chloride source (NaOCl vs Ca(CIO)₂), increasing the chloride concentration (up to 125,000 ppm), increasing the exposure time (24 hours vs 18 hours), and leaving the pH unadjusted (up to pH of 11.56) as set out in Table 3.

The effect of the bleaching was quantified using a 60° glossimeter (measurements taken above and below the submersion line) and by visual inspection using the grayscale assessment criteria to assign a score per AS/NZS 1838-1994.

Per entry 1 of Table 3, a panel (Comp-1) coated with a commercially available pigmented Iso-NPG gelcoat available from RF Composites (281S Gelcoat with pigment ground in a saturated polyester grinding resin) was evaluated in a bleaching test according to Australian Standard Test AS/NZS 1838-1994. Although the panel passed the test, visible bleaching and some surface corrosion was observed on the submerged portion of the panel.

Per entry 2, a panel coated with G5-1 gelcoat according to the invention was tested under the same conditions. No bleaching or other degradation of the panel was observed.

Per entries 3 to 4, panels coated with the G5-1 gelcoat were subjected to increasingly severe bleaching conditions. No bleaching or other degradation of the gel-coated portion of the panels was observed, even at extreme conditions with 125,000 ppm NaOCl. The reverse sides of the panels, where the uncoated vinyl ester laminate was exposed to the solution, were heavily corroded when exposed to 62,500 and 125,000 ppm NaOCl.

Per entry 5, a panel (Comp-2) coated with a commercially available pigmented and glitter-containing Ortho-NPG pool gelcoat was evaluated at harsh bleaching conditions (5,000 ppm Cl). The gelcoat was severely bleached (discoloured) and corroded under these conditions.

Per entries 6 to 9, the effect of increasing coated pigment content was evaluated, using pigment P/2-1/GPTA-10 according to the invention in an amount of from 4.5 to 17.5 wt. % (gelcoats G5-2 to G5-5). A harsher version of the AS/NZS 1838-1994 test was used in the evaluation. No polyester-polyurethane dimethacrylate prepolymer was added to the gelcoat composition apart from that present in the coated pigment. No bleaching or physical degradation was observed for any of the samples. By contrast, conventional gelcoats are more susceptible to visible degradation at higher pigment contents.

Per entries 10 and 11, the protective effect of pigment coatings containing polyester-polyurethane dimethacrylate against harsh bleaching conditions was evaluated, using 10 wt. % pigment P/2-1/GPTA-10 according to the invention (gelcoat G5-6). No polyester-polyurethane dimethacrylate prepolymer was added to the gelcoat composition apart from that present in the coated pigment. No colour loss through bleaching was observed for either of the samples. However, some corrosion in the form of pitting was apparent in the surface of the coatings.

Per entries 12 to 15, panels coated with G5-7 gelcoat according to the invention were subjected to increasingly severe bleaching condition. This clear gelcoat included 10 wt. % of resin R/2-1/SM containing polyester-polyurethane dimethacrylate prepolymer, but no pigment. Little corrosion was apparent and the gloss of all samples remained within an acceptable range even after exposure to severe bleaching conditions. The reverse side of the panels, where the uncoated vinyl ester laminate was exposed to the solution, was heavily corroded in the more extreme tests.

Per entries 16 and 17, panels coated with G5-8 gelcoat according to the invention were tested under severe bleaching conditions. These panels contained polyester-polyurethane dimethacrylate prepolymer both blended into the base gelcoat and coated onto the pigment. No bleaching or other degradation was observed—the gelcoat provided excellent protection against both discolouration and corrosion such as pitting.

Per entry 18, a panel (Comp-3) coated with a commercially available pigmented and glitter-containing Iso-NPG pool gelcoat was evaluated at extremely severe bleaching conditions (100,000 ppm NaOCl). Severe degradation—including cracking of the cured gelcoat and bleaching of the pigment, was observed.

Per entry 19, a panel coated with G5-9 gelcoat according to the invention was tested at the same severe bleaching condition as entry 18. The gelcoat retained structural integrity and the pigment was protected against discolouration.

TABLE 3

| | | | Gloss | Gloss | |
|---|---|---|---|---|---|
| | | | level | level | |
| | | | above | below | |
| Entry | Panel | Bleaching Test | line | line | Grayscale test result/Observation |
| 1 | Comp-1 | 0.5 g Ca(ClO)₂, 325 ppm Cl, 18 h, pH 6.5 | 91.0 | 88.8 | 3.5 Line easily visible, surface gloss still good, |
| | | | | | pigment affected |
| 2 | G5-1 | 0.5 g Ca(ClO)₂, 325 ppm Cl, 18 h, pH 6.5 | 91.6 | 91.0 | 5 Cannot see line difference |
| 3 | G5-1 | NaClO, 62,500 ppm Cl, 18 h, pH 6.5 (50% dilution | 94.7 | 93.4 | 5 Cannot see line difference |
| | | with distilled water of 12.5% liquid pool chlorine) | | | |
| 4 | G5-1 | NaClO, 125,000 ppm Cl, 18 h, pH 6.5 (undiluted | 94.7 | 93.1 | 5 Cannot see line difference |
| | | 12.5% liquid pool chlorine) | | | |
| 5 | Comp-2 | Na(ClO)₂, 5,000 ppm Cl, 18 h, pH 6.5 (12.5% | 87.4 | 42.7 | 2 Severely damaged, glitter eaten, dark blue |
| | | liquid pool chlorine diluted with 96% distilled water) | | | spots where glitter eaten |
| 6 | G5-2 | 1.0 g Ca(ClO)₂, 650 ppm Cl, 24 h, pH 6.5 | 93.4 | 92.3 | 5 Cannot see line difference |
| 7 | G5-3 | 1.0 g Ca(ClO)₂, 650 ppm Cl, 24 h, pH 6.5 | 93.8 | 92.5 | 5 Cannot see line difference |
| 8 | G5-4 | 1.0 g Ca(ClO)₂, 650 ppm Cl, 24 h, pH 6.5 | 93.8 | 94.0 | 5 Cannot see line difference |
| 9 | G5-5 | 1.0 g Ca(ClO)₂, 650 ppm Cl, 24 h, pH 6.5 | 91.6 | 92.3 | 5 Cannot see line difference |
| 10 | G5-6 | Na(ClO)₂, 5,000 ppm Cl, 24 h, pH 6.5 (12.5% | 95.9 | 97.4 | 5 Cannot see line difference |
| | | liquid pool chlorine diluted with 96% distilled water) | | | |
| 11 | G5-6 | Na(ClO)₂, 5,000 ppm Cl, 24 h, pH 11.56 (12.5% | 95.7 | 95.8 | 4.5 Barely visible fade line |
| | | liquid pool chlorine diluted with 96% distilled water, | | | |
| | | pH not corrected) | | | |
| 12 | G5-7 | 0.5 g Ca(ClO)₂, 325 ppm Cl, 18 h, pH 6.5 | 89.0 | 88.1 | 5 Cannot see line difference |
| 13 | G5-7 | 1.0 g Ca(ClO)₂, 650 ppm Cl, 24 h, pH 6.5 | 89.4 | 87.4 | 5 Cannot see line difference |
| 14 | G5-7 | 4 g Ca(ClO)₂, 2600 ppm Cl, 24 h, pH 6.5 | 85.3 | 84.2 | 5 Cannot see line difference |
| 15 | G5-7 | 20 g Ca(ClO)₂, 13,000 ppm Cl, 24 h, pH 6.5 | 86.3 | 85.0 | 5 Cannot see line difference |
| 16 | G5-8 | Na(ClO)₂, 2,500 ppm Cl, 24 h, pH 6.5 (12.5% | 94.4 | 93.2 | 5 Cannot see line difference |
| | | liquid pool chlorine diluted with 98% distilled water) | | | |
| 17 | G5-8 | Na(ClO)₂, 2500 ppm Cl, 24 h, pH 10.68 (12.5% | 97.7 | 95.9 | 5 Cannot see line difference |
| | | liquid pool chlorine diluted with 98% distilled water, | | | |
| | | pH not corrected) | | | |
| 18 | Comp-3 | NaClO, 100,000 ppm Cl, 24 h, pH 6.5 (undiluted 12.5% | 95.1 | 1.4 | Gelcoat destroyed (cracking); discoloration |
| | | liquid pool chlorine) | | | due to pigment bleaching |
| 19 | G5-9 | NaClO, 100,000 ppm Cl, 24 h, pH 6.5 (undiluted 12.5% | 95.0 | 7.6 | Gelcoat remains intact; loss of gloss but pigment |
| | | liquid pool chlorine) | | | protected |

### Example 8

A gelcoat composition according to < . . . > was trialed in the manufacture of a full-size swimming pool. The gelcoat was catalysed with a MEKP initiator and sprayed onto a swimming pool mould pretreated with a release agent. The activated gelcoat composition was applied to the horizontal top surface of the mould (forming the floor of the pool shell) as a film of 800 micron thickness, before spraying the side walls in two successive applications of 400 micron thickness each, spaced apart by one hour.

While a two-step application was used on the vertically oriented side walls to prevent flow of the sprayed gelcoat composition, it was surprisingly found that this approach could be avoided for the horizontal top surface. Despite the 800 micron thickness, the activated gelcoat formed a consistent film with no drainage and the resultant cured gelcoat had high gloss and negligible porosity. By contrast, a two-step application was required with a conventional Iso-NPG gelcoat to avoid air-capture and resultant porosity in the cured gelcoat. The use of the gelcoat containing polyester-polyurethane prepolymer thus reduced the time needed to produce the final swimming pool gelcoat, and produced a glossier gelcoat finish with improved resistance to bleaching when compared to the conventional Iso-NPG gelcoat.

Those skilled in the art will appreciate that the invention described herein is susceptible to variations and modifications other than those specifically described. It is understood that the invention includes all such variations and modifications which fall within the spirit and scope of the present invention.

1. A gelcoat composition comprising:
curable polymeric components comprising: (i) an unsaturated polyester base resin and (ii) a polyester-polyurethane prepolymer, wherein the polyester-polyurethane prepolymer is terminally functionalised with polymerizable ethylenically unsaturated functional groups; and
reactive diluent,
wherein the unsaturated polyester base resin is present in an amount of greater than 50 wt. % of the curable polymeric components, and
wherein the polyester-polyurethane prepolymer is present in an amount of no more than 25 wt. % of the gelcoat composition.

2. A gelcoat composition according to claim 1, wherein the polyester-polyurethane prepolymer comprises one or more residues of a polyester diol, wherein the polyester diol is a reaction product of at least one aliphatic diol and at least one aliphatic dicarboxylic acid or anhydride thereof.

3. A gelcoat composition according to claim 2, wherein the aliphatic dicarboxylic acid or anhydride thereof comprises an ethylenically unsaturated aliphatic diacid or anhydride thereof.

4. (canceled)

5. A gelcoat composition according to claim 2, wherein the aliphatic diol comprises one primary hydroxyl group and one secondary hydroxyl group.

6. A gelcoat composition according to claim 2, wherein at least 80 wt. % of the polyester diol is a reaction product of two molecules of the aliphatic diol and one molecule of the aliphatic dicarboxylic acid or anhydride thereof.

7. A gelcoat composition according to claim 1, wherein the polyester-polyurethane prepolymer comprises residues of at least one aliphatic diisocyanate.

8. (canceled)

9. A gelcoat composition according to claim 1, wherein the polymerizable ethylenically unsaturated functional groups comprise (meth)acrylate groups.

10. A gelcoat composition according to claim 1, wherein the polyester-polyurethane prepolymer comprises terminal residues of at least one end-capping molecule comprising one polymerizable ethylenically unsaturated functional group and one isocyanate-reactive functional group, wherein the end-capping molecule is a hydroxyalkyl(meth)acrylate.

11. (canceled)

12. A gelcoat composition according to claim 1, wherein the polyester-polyurethane prepolymer comprises diisocyanate residues and polyester diol residues in a mol ratio of between 6:5 and 2:1.

13. (canceled)

14. A gelcoat composition according to claim 1, wherein the polyester-polyurethane prepolymer is present in an amount of no more than 15 wt. % of the gelcoat composition.

15. A gelcoat composition according to claim 1, wherein at least a portion of the polyester-polyurethane prepolymer is blended with the reactive diluent and the unsaturated polyester base resin.

16. A gelcoat composition according to claim 1, further comprising decorative particles.

17. A gelcoat composition according to claim 16, wherein at least a portion of the polyester-polyurethane prepolymer is present in a coating on the decorative particles.

18. A gelcoat composition according to claim 1, wherein the unsaturated polyester base resin comprises an Iso-NPG base resin.

19. (canceled)

20. (canceled)

21. (canceled)

22. A gelcoat composition according to claim 1, wherein the polyester-polyurethane prepolymer comprises molecules having a structure according to Formula 3-1 or Formula 3-2:
wherein each X′ is independently a C₃-C₆ alkylene group;
wherein each R′ is independently methyl or ethyl; and
wherein the average value of n′ in the molecules is between 1 and 5.

23. (canceled)

24. (canceled)

25. A coated particulate for use in a gelcoat composition, the coated pigment comprising decorative particles coated with a curable resin composition comprising a polyester-polyurethane prepolymer, wherein the polyester-polyurethane prepolymer is terminally functionalised with polymerizable ethylenically unsaturated functional groups.

26. A coated particulate according to claim 25, wherein the decorative particles comprise pigment particles and/or glitter.

27. A coated particulate according to claim 25, wherein the curable resin composition further comprises a multifunctional reactive monomer.

28. A coated particulate according to claim 25, wherein the polyester-polyurethane prepolymer comprises one or more residues of a polyester diol, wherein the polyester diol is a reaction product of at least one aliphatic diol and at least one aliphatic dicarboxylic acid or anhydride thereof; and
residues of at least one aliphatic diisocyanate,
wherein at least 80 wt. % of the polyester diol is a reaction product of two molecules of the aliphatic diol and one molecule of the aliphatic dicarboxylic acid or anhydride thereof.

29. (canceled)

30. (canceled)

31. (canceled)

32. (canceled)

33. (canceled)

34. (canceled)

35. A method of producing a pool, the method comprising: activating a gelcoat composition according to claim 1 or a gelcoat composition comprising a coated particulate according to claim 25 to form an activated gelcoat composition;
applying the activated gelcoat composition to a pool mould or pool wall substrate; and
curing the activated gelcoat composition to produce a gelcoat for the internal walls of a pool.

36. (canceled)
